(19) United States
(12) Patent Application Publication
(10) Pub. No.: US 2006/0152100 A1
(43) Pub. Date: Jul. 13, 2006

(54) Vehicle alternator having reduced windings

(75) Inventors: Hanyang B. Chen, Ypsilanti, MI (US); Kirk E. Neet, Saline, MI (US); Eric David Bramson, Ann Arbor, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/031,261

(22) Filed: Jan. 7, 2005

(51) Int. Cl. H02K 3/00; H02K 1/00

(52) U.S. Cl. 310/179

(57) ABSTRACT

A stator for an electric machine includes a generally cylindrically-shaped stator core having a plurality of circumferentially-spaced and axially-extending core teeth that define a plurality of circumferentially-spaced and axially-extending core slots extending between first and second ends of the stator core. Within the core is a stator winding having a plurality of phases, each of the phases including at least one conductor having a plurality of slot segments housed in the core slots. The slot segments are alternately connected at the first and second ends of the stator core by a plurality of end loop segments. The stator core defines an inner diameter and each of the core slots has an end. The winding only partially fills the core slots between the inner diameter and the ends such that there is empty space between the inner diameter and the end within each of the core slots.

### FIELD OF THE INVENTION

The present invention relates generally to electric machines and, in particular, to a reduced winding for an electric machine having a core and a winding.

### BACKGROUND OF THE INVENTION

Electric machines, such as alternating current electric generators, or alternators are well known. Prior art alternators typically include a stator assembly and a rotor assembly disposed in an alternator housing. The stator assembly is mounted to the housing and includes a generally cylindrically-shaped stator core having a plurality of slots formed therein. The rotor assembly includes a rotor attached to a generally cylindrical shaft that is rotatably mounted in the housing and is coaxial with the stator assembly. The stator assembly includes a plurality of wires wound thereon, forming windings. The stator windings are formed of slot segments that are located in the core slots and end loop segments that connect two adjacent slot segments of each phase and are formed in a predetermined multi-phase (e.g. three or six) winding pattern in the slots of the stator core.

The rotor assembly can be any type of rotor assembly, such as a “claw-pole” rotor assembly, which typically includes opposed poles as part of claw fingers that are positioned around an electrically charged rotor coil. The electric current in the rotor coil produces a magnetic field in the claw fingers. As a prime mover, such as a steam turbine, a gas turbine, or a drive belt from an automotive internal combustion engine, rotates the rotor assembly, the magnetic field of the rotor assembly passes through the stator windings, inducing alternating electrical currents in the stator windings in a well known manner. The alternating electrical currents are then routed from the alternator to a distribution system for consumption by electrical devices or, in the case of an automotive alternator, to a rectifier and then to an automobile battery.

One type of device is a high slot fill stator, which is characterized by rectangular shaped conductors whose width, including any insulation fit closely to the width, including any insulation of the rectangular shaped core slots. High slot fill stators are advantageous because they are efficient and help produce more electrical power per winding than other types of prior art stators.

One disadvantage of the high slot fill stators is the difficulty of providing alternators that provide different dc output currents. Currently, alternators for different applications are developed and manufactured independently such that each application required a completely different alternator. The tooling and manufacturing costs associated with providing many different alternators is very high. Therefore, there is a need for an alternator that can easily be modified to provide different dc output currents while using the same stator core and winding.

### SUMMARY OF THE INVENTION

A stator for a dynamoelectric machine according to the present invention includes a generally cylindrically-shaped stator core having a plurality of circumferentially-spaced and axially-extending core teeth that define a plurality of circumferentially-spaced and axially-extending core slots in a surface thereof. The core slots extend between a first and a second end of the stator core. The stator also includes a multi-phase stator winding. Each of the phases includes a plurality of slot segments disposed in the core slots that are alternately connected at the first and second ends of the stator core by a plurality of end loop segments. The slot segments and likely the end loop segments of a high slot fill winding are typically rectangular in cross sectional shape. The end loop segments of the winding may be interlaced or cascaded. An interlaced winding includes a majority of end loops that connect a slot segment housed in one core slot and in one radial position with a slot segment housed in another core slot in a different radial position. In contrast, a cascaded winding includes a majority of end loop segments that connect a slot segment housed in one radial position of a core slot with another slot segment housed in the same radial position of another core slot. The term radial position, utilized herein, refers to the position of a slot segment housed in the core slots with respect to the other slot segments housed in the same core slot—i.e. the outermost slot segment housed in a core slot is defined as being located in the outermost radial position, the second outermost slot segment housed in a slot is defined as being located in the second outermost radial position, and so forth. The term, conductor portion, utilized herein, is defined as being a portion of a conductor that includes at least three consecutive slot segments connected by at least two end loop segments. A cascaded winding is further defined as a winding including a plurality of conductor portions of all of the phases located in the same general circumferential location, wherein all of the conductor portions could be sequentially radially inserted from the central axis of the stator core.

The stator core defines an inner diameter and an outer diameter. The “normal” path of the magnetic flux is to encircle around a core slot by entering a tooth at the inner diameter, traveling radially outward down the tooth, traveling circumferentially across the yoke and finally traveling radially inward down another tooth. This path for the magnetic flux encircles and therefore links each slot segment located in the encircled core slot. However, some amount of the magnetic flux short circuits this path by prematurely crossing the slot before it reaches the yoke—this portion of the magnetic flux is known as slot leakage flux. This slot leakage flux encircles, and therefore links, only the slot segments that are located radially inward of the radial point where the slot leakage flux pre-maturely crosses the slot. Therefore, slot leakage flux can cause slot segments located toward the inner diameter to be linked by more flux and therefore have more generated output current than slot segments located toward the end of the core slot. The slot leakage flux and the amount of slot leakage flux, therefore, enable the solution of this invention.

The circumferential width of a non-permeable material, such as the air, copper wire and insulator, found in a core slot increases the magnetic reluctance to allow magnetic flux to flow. Therefore, the amount of slot leakage flux is increased for stators having core slots with narrower circumferential widths than the circumferential width of a typical stator core. Recent high slot fill stator innovations require a winding comprised of end loop segments having an increased pitch from the typical pitch number of three to a larger number (such as six) and therefore requires a larger number of core slots. Because of circumferential space limitations, a stator having a larger number of core slots must have a narrower circumferential width of each core slot. Due to these relationships, a stator winding with end loop segments having an increased pitch, have a greater value of slot leakage flux and are therefore readily adaptable to the solution of this invention.

The solution, to create a family of electrical machines with differing output currents, involves only partially filling the core slots with slot segments and varying the radial location of the slot segments for different electrical machines. The varying radial location of the slot segments of different machines, allows the effect of the slot leakage flux to create different generated output currents for the different machines. The winding is inserted into the core such that the slot segments only partially fill the core slots between the inner diameter and the ends of the core slots, such that there is empty space located between the inner diameter and the ends of the core slots within each of the core slots. The term empty space, utilized herein, is defined as a space in a core slot which is comprised of a material that is not part of the electrical conductor and has a radial depth which is at least equal to the radial depth of one of the conductors housed in the core slots. In one aspect, the slot segments are positioned adjacent the inner diameter such that there is empty space located between the slot segments and the ends of the core slots within each of the core slots. In another aspect, the slot segments are positioned adjacent the ends of the core slots such that there is empty space located between the slot segments and the inner diameter of the stator core within each of the core slots. In still another aspect, the slot segments are positioned between the inner diameter and the ends of the core slots such that there is empty space located between the slot segments and the inner diameter of the stator core and there is empty space between the slot segments and the ends of the core slots within each of the core slots.

In any of the aspects described above, a filler material may be placed within the empty space within each core slot. The filler material can act to keep the winding in position within the core slots, and may be formed from a dampening material to dampen vibration and noise within the stator.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a perspective view of a stator core in accordance with the present invention prior to insertion of the stator winding;

FIG. 2 is a cross sectional view of a portion of the stator core after insertion of the stator winding wherein the winding is positioned adjacent an inner diameter of the stator core;

FIG. 3 is a cross sectional view of a portion of the stator core after insertion of the stator winding wherein the winding is positioned adjacent the ends of the core slots of the stator core;

FIG. 4 is a cross sectional view of a portion of the stator core after insertion of the stator winding wherein the winding is positioned between the inner diameter and the ends of the core slots such that there is a space between the winding and the inner diameter and a space between the windings and the ends of the core slots;

FIG. 5 is a cross sectional view similar to FIG. 2 wherein a filler material is placed within the space between the winding and the ends of the core slots of the stator core;

FIG. 6 is a cross sectional view similar to FIG. 3 wherein a dampening material is placed within the space between the winding and the inner diameter of the stator core;

FIG. 7 is a perspective view of an end loop segment of a portion of a stator winding in accordance with the present invention;

FIG. 7a is a perspective view of a layer of end loop segments of a portion of a stator winding in accordance with the present invention including the end loop segment of FIG. 7;

FIG. 7b is a perspective view of a plurality of layers of end loop segments of a stator winding in accordance with the present invention including the layer of FIG. 7a;

FIG. 7c is a perspective view of a plurality of layers of end loop segments of the stator winding shown in FIG. 7b including a plurality of slot segments and end loop segments in accordance with the present invention; and

FIG. 8 is a cross sectional view of an alternator in accordance with the present invention.

### DESCRIPTION OF THE EMBODIMENTS

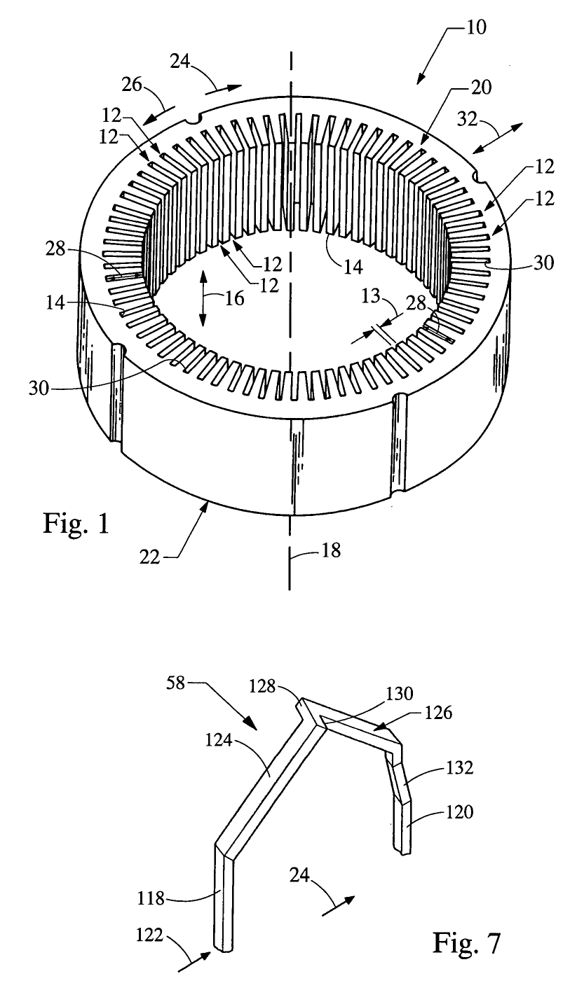

Referring now to FIG. 1, a generally cylindrically-shaped stator core is indicated generally at 10. The stator core 10 includes a plurality of core slots 12 formed in a circumferential inner diameter 14 thereof. The core slots 12 extend in an axial direction, indicated by an arrow 16, parallel to a central axis 18 of the stator core 10 between a first end 20 and a second end 22 thereof. An axially upward direction is defined as moving toward the first end 20 of the stator core 10 and an axially downward direction is defined as moving toward the second end 22 of the stator core 10.

Preferably, the core slots 12 are equally spaced around the circumferential inner diameter 14 of the stator core 10. A circumferential clockwise direction is indicated by an arrow 24 and a circumferential counterclockwise direction is indicated by an arrow 26.

The core slots 12 define a radial depth 28, between ends 30 of the core slots 12 and the inner diameter 14 of the stator core 10. This radial depth 28 is along radial direction, indicated by arrow 32. The core slots 12 are adapted to receive a stator winding, discussed in more detail below. A radial inward direction is defined as moving towards the central axis 18 of the stator core 10 and a radial outward direction is defined as moving away from the central axis 18. The core slots 12 may have rectangular cross sectional shape as can be seen in FIG. 1.

Each of the stator core slots 12 has an end 30. The slot segments 51 of the winding 50 are housed within the core slots 12 and only partially fill the core slots 12 between the inner diameter 14 and the ends 30 of the core slots 12. This leaves empty space 34 somewhere between the inner diameter 14 and the ends 30 of the core slots 12 within each of the core slots 12.

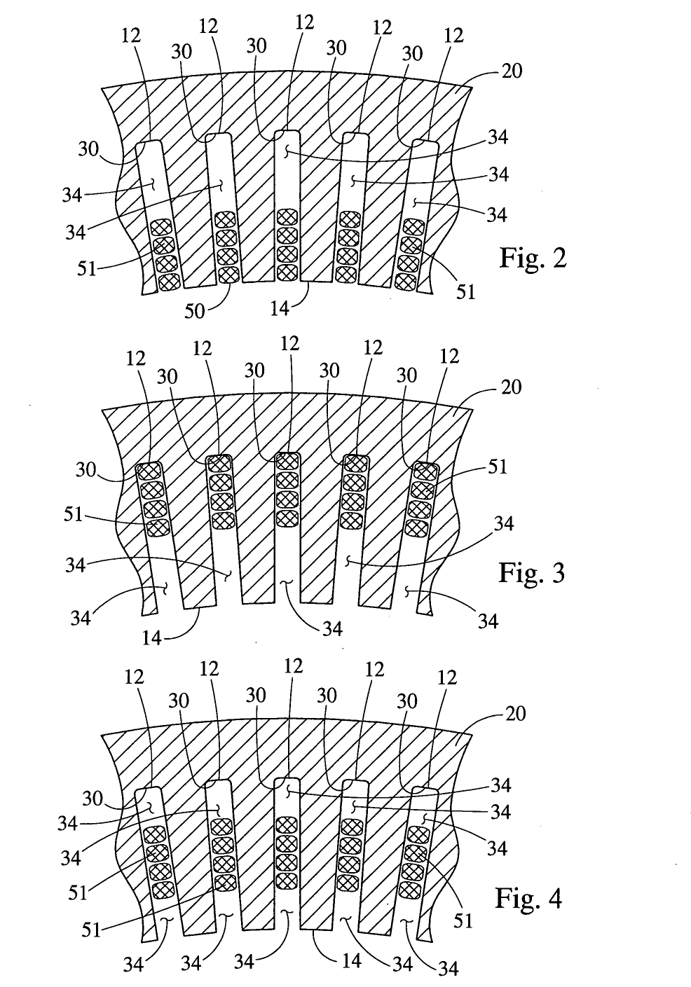

Referring to FIG. 2, a cross section of a portion of a stator core 10 with the slot segments 51 placed therein is shown wherein the slot segments 51 is positioned adjacent the inner diameter 14 such that there is empty space 34 between the slot segments 51 and the ends 30 of the core slots 12 within each of the core slots 12. Alternatively, the slot segments 51 can be positioned adjacent the ends 30 of the core slots 12 such that there is empty space 34 between the slot segments 51 and the inner diameter 14 of the stator core 10 within each of the core slots 12, as shown in FIG. 3.

Finally, the slot segments 51 may be positioned between the inner diameter 14 and the ends 30 of the core slots 12 such that there is empty space 34 between the slot segments 51 and the inner diameter 14 of the stator core 10 and there is empty space 34 between the slot segments 51 and the ends 30 of the core slots 12 within each of the core slots 12, as shown in FIG. 4.

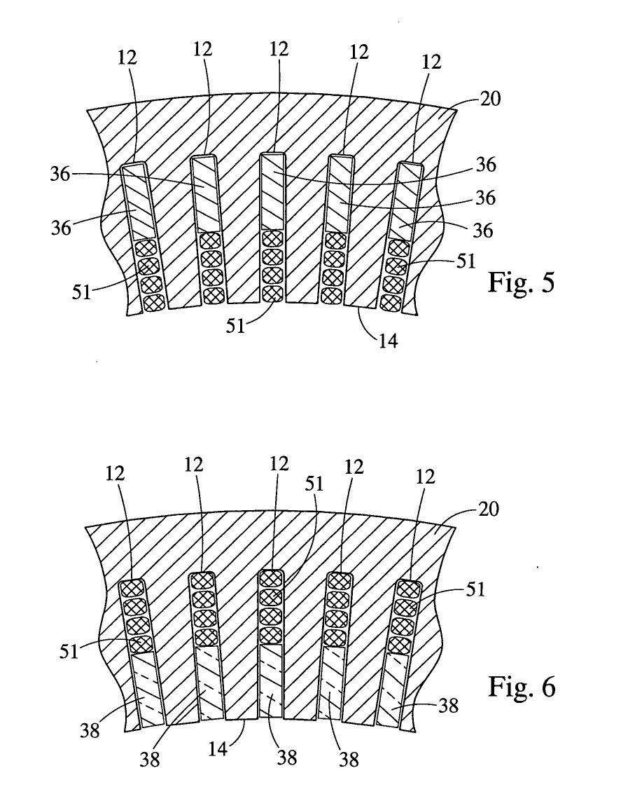

Referring to FIG. 5, a stator core similar to the one shown in FIG. 2 is shown wherein a filler material 36 is placed within the empty space 34. The presence of the filler material 36 occupies the empty space 34 to keep the slots segments 51 in place within the core slots 12 of the stator core 10 until a varnish can be applied to the winding 50. Varnish is generally recognized to those skiled in the art to be any type of bonding agent applied to the windings of an electric machine for the purpose of securing the wires in their positions. In FIG. 6, the empty space 34 is filled with a dampening material 38. The dampening material 38 will perform all of the functions that the filler material 36 does, but will also provide vibration and noise reduction within the stator core 10 and winding 50. The filler material could also be used in any spaces 34 such as the spaces shown in FIG. 4.

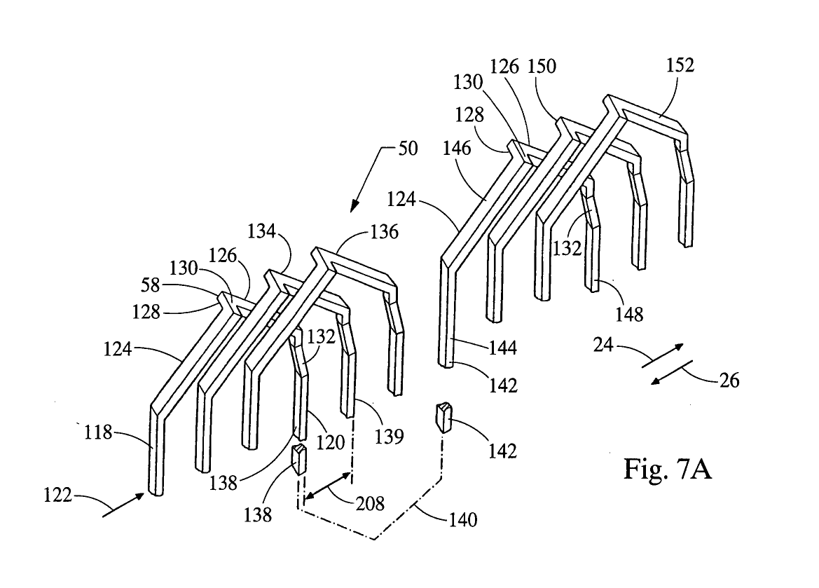

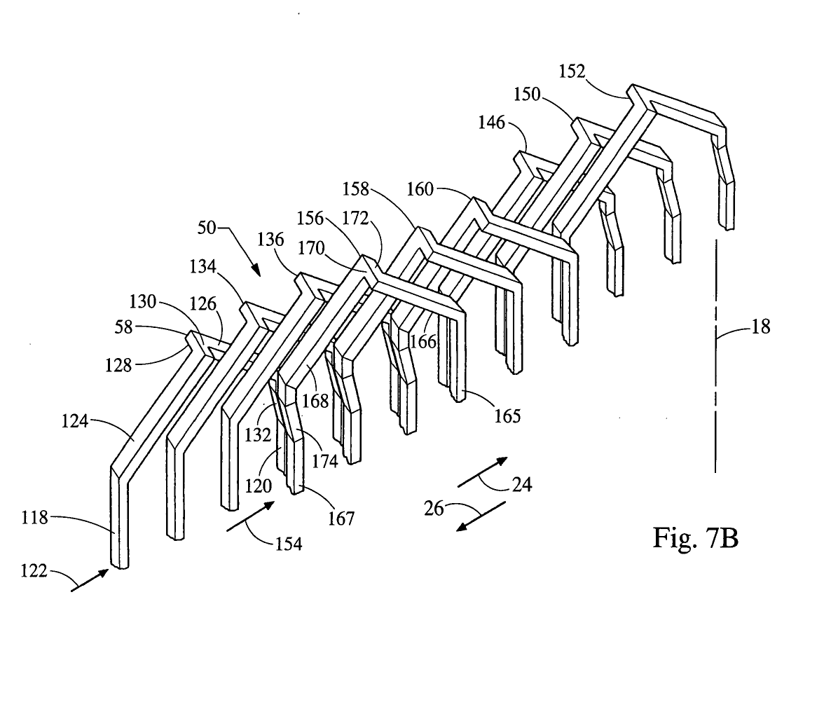

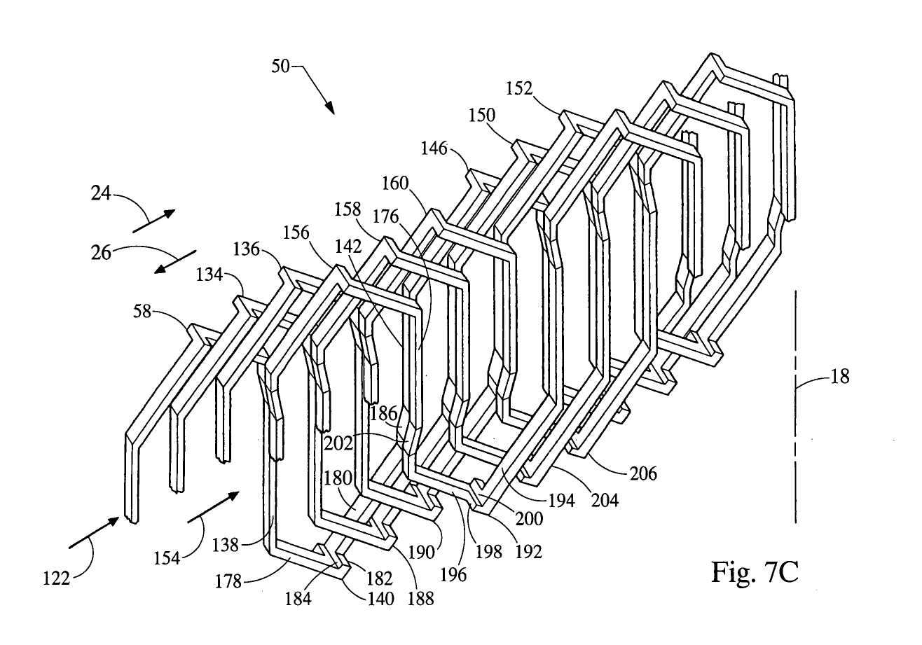

The cascaded winding 50 for the stator is shown in FIGS. 7 through 7c. Each of the continuous conductors has a plurality of slot segments disposed in the core slots 12. The term continuous, utilized herein, refers to a conductor including at least two end loop segments and connected to at least three slot segments that extends circumferentially around the core without any welds or connections. The slot segments are alternately connected at the first and second ends 20, 22 of the stator core 10 by a plurality of end loop segments. Each of the slot segments of a particular layer are located in the same radial position and therefore are likely to be at substantially the same radial distance from the central axis 18 of the stator core 10 and the end loop segments form a cascaded winding pattern. The term layer, utilized herein, refers to a conductor which extends circumferentially around the core including at least two end loop segments which connect at least three slot segments wherein the slot segments are located in the same radial position.

Referring now to FIG. 7, the end loop segment, indicated generally at 58, is adapted to be a part of the stator winding 50 and includes a first substantially straight end portion 118 and a second substantially straight end portion 120 that are each proximate to a respective slot segment, discussed in more detail below, of the stator winding. The first end portion 118 and the second end portion 120 of the end loop segment 58 are at a substantially same radial distance from the central axis 18 of the stator core 21. The first end portion 118 and the second end portion 120 form a portion of a layer, indicated generally at 122, of the stator winding whose slot segments are located in the same radial position in the core slots 12. Although end portions, such as 118 and 120, are described as entities, they may, in fact, just be portions of the slot segments, discussed in more detail below.

The end loop segment 58 includes a first sloped portion 124 and a second sloped portion 126 that meet at an apex portion 128. The first sloped portion 124 is substantially co-radial with the slot segments of layer 122, the first end portion 118 and the second end portion 120. The second sloped portion 126 is substantially non-co-radial with the slot segments of layer 122, the first end portion 118 and the second end portion 120. The apex portion 128 includes a first radial extension portion 130. The first radial extension portion 130 extends from the first sloped portion 124 in the radially outward direction, which provides a radial outward adjustment for the end loop segment 58. A second radial extension portion 132 connects the second sloped portion 126 and the second end portion 120. The second radial extension portion 132 extends from the second sloped portion 126 in the radially inward direction, which provides a radial inward adjustment for the end loop segment 58. Although the radial extension portions, such as 130 and 132, shown in FIGS. 7, 7a, 7b, and 7c appear as sharp bends, it is obvious to those skilled in the art that typical radial extension portions would be more gentle in nature and include radii, not shown.

While the end loop segment 58 has been shown wherein the radial outward adjustment is adjacent the apex portion 128 and the radial inward adjustment is adjacent the second sloped portion 126, those skilled in the art can appreciate that the radial outward and inward adjustments can be on any one or on any two of the first sloped portion 124, the second sloped portion 126, and the apex portion 128 in order to provide the cascaded winding pattern, described in more detail below.

Referring now to FIG. 7a, the end loop segment 58 of FIG. 7 is shown adjacent a plurality of substantially identical end loop segments, indicated generally at 134 and 136. The end loop segments 58, 134, and 136 each form a portion of the layer 122 of the stator winding 50. The end loop segments 58, 134, and 136 are shown in a three-phase winding pattern but those skilled in the art will appreciate that the end loop segments 58, 134, and 136 may be formed in, for example, a six-phase winding pattern, or any other winding pattern advantageous for producing electricity or for generating torque, as in the case of an electric motor. In a three-phase winding the end loop segments typically, but not necessarily, have a pitch equal to three as can be best seen in FIG. 7a where end loop segment 140 connects a slot segment 138 disposed in a first core slot with another slot segment 142 disposed in a core slot which is located three core slots from the first core slot. In a six-phase winding the end loop segments typically have a pitch equal to six. The end loop segments 58, 134, and 136 are preferably each disposed at the first end 20 of the stator core 10.

The portion 120 attaches to a first slot segment, shown schematically as 138, which extends through a one of the core slots 12 to the second end 22 of the stator core 10. As the first slot segment 138 exits the second end 22, the first slot segment 138 is attached to an end of another end loop segment, shown schematically at 140, which is described in more detail below. The end loop segment 140 is attached at another end to a second slot segment, shown schematically at 142. The second slot segment 142 extends upwardly through another one of the core slots 12 of the stator core 10 and attaches to a portion 144 of an end loop segment 146, which is substantially identical to the end loop segments 58, 134, and 136. Similarly, a portion 148 of the end loop segment 146 connects to another slot segment, discussed in more detail below. The pattern of connecting end loop segments 58, 140, and 146 and slot segments, such as the slot segments 138 and 142, as outlined above, continues about the circumference of the stator core 10 to form a first layer, such as the layer 122, of a single phase of the stator winding 50.

The end loop segment 146 is shown adjacent a plurality of substantially identical end loop segments, indicated generally at 150 and 152. The end loop segments 146, 150, and 152 are each connected to a corresponding plurality of slot segments, discussed in more detail below, such as the slot segment and 142, which are each disposed in a respective core slot 12 of the stator core 10. The slot segments are attached to a plurality of end loop segments, discussed in more detail below. The end loop segments 134, 136, 150, and 152, when attached to the slot segments and end loop segments, each form a respective continuous first layer of the complete stator winding 50 that is wound about the circumference of the stator core 10.

Preferably, each of the slot segments 138 and 142 and each of the end loop segment 58, 134, 136, 140, 146, 150, and 152 are formed from a rectangular wire and have a cross-sectional shape having a substantially constant circumferential width and radial width and therefore substantially equal area, however, other shapes could also be employed such as round, triangular or elliptical. For those skilled in the art, it is known that a square shaped conductor is considered a type of a rectangular shaped conductors and that a typical rectangular conductor may include radii on the corners intermediate two adjacent edges.

Referring now to FIGS. 7b and 7c, the first layer 122 of the end loop segments 58, 134, 136, 146, 150, and 152 of FIG. 7a, is shown with a second layer of end loop segments indicated generally at 154. The layer 154 is located radially inward of the layer 122 at a predetermined radial distance from the layer 122. The second layer 154 includes a plurality of end loop segments, indicated generally at 156, 158, and 160. The layers 122 and 154 together form a portion of the stator winding 50. The conductor of the second layer 154 including the end loop segment 156 is similar to the conductor of the first layer 122 including the end loop segment 58 except that it is inserted into the core slots 12, shifted by a predetermined number of slots, discussed in more detail below, and it has end loop segments on a first end of the stator core 10, such as the end loop segment 156, that extend radially outwardly at the apex portion 170 in the counterclockwise direction 26, which is opposite the end loop segments, such as the end loop segment 58, of the first layer 122, which extend radially outwardly at the apex portion 128 in the clockwise direction 24.

The end loop segment 156 includes a first sloped portion 166 and a second sloped portion 168 connected by an apex portion 170. The first sloped portion 166 is substantially co-radial with the slot segments of the second layer 154, the first end portion 165 and the second end portion 167. The second sloped portion 168 is substantially non-co-radial with the slot segments of the second layer 154, the first end portion 165 and the second end portion 167. The apex portion 170 includes a first radial extension portion 172. The first radial extension portion 172 extends from the first sloped portion 166 in the radially outward direction, which provides a radial outward adjustment for the end loop segment 156. A second radial extension portion 174 connects the second sloped portion 168 and the second end portion 167. The second radial extension portion 174 extends from the second sloped portion 168 in the radially inward direction, which provides a radial inward adjustment for the end loop segment 156.

As can best be seen in FIG. 7b, the non-co-radial portion 168 of end loop segment 156 extends radially outward where it becomes substantially co-radial with the slot segments of the first layer 122, the first end portion 118 and the second end portion 120, but because it is shifted by a predetermined number of slots, it does not violate the space of the end loop segments of the first layer 122. This allows the end loop segments of the two layers, 122 and 154 to cascade together forming a two layer winding 50, which extends radially outward by one substantial wire width beyond the slot segments of the first layer 122 but does not substantially extend radially inward beyond the slot segments of the innermost layer 154.

For a winding with a plurality of layers, a third layer (not shown) which is substantially identical to the first layer 122, would have non-co-radial portions that would extend radially outward and be substantially co-radial with the slot segments of the second layer 154 and therefore cascade with the second layer 154. For a pattern where the radial layers alternate between being substantially identical with the first layer 122 and the second layer 154, a pattern develops where the winding 50 only extends radially outward by one wire width for the outermost layer 122 but not radially inward of the slot segments of the innermost layer. This cascading effect allows a winding 50 with a plurality of layers to be inserted into a stator core 10, that extend radially outwardly by one substantial wire width while not extending radially inwardly. The end loop segments 158 and 160 are substantially identical to the end loop segment 156. The radial outward and inward adjustments for the layers 122, 154 form a cascaded winding pattern shown in FIGS. 7b and 7c.

Referring to FIG. 7c, the first layer 122 and the second layer 154 are shown with a plurality of slot segments 176, which are substantially identical to the slot segments 138 and 142. The end loop segment 140 of FIG. 7a is shown having a first sloped portion 178 and a second sloped portion 180 connected by an apex portion 182. The first sloped portion 178 is substantially co-radial with slot segments 138 and 142 of the first layer 122. The second sloped portion 180 is substantially non-co-radial with the slot segments 138 and 142 of the first layer 122. The apex portion 182 includes a first radial extension portion 184. The first radial extension portion 184 extends from the first sloped portion 178 in the radially outward direction, which provides a radial outward adjustment for the end loop segment 140. A second radial extension portion 186 connects the second sloped portion 180 and the slot segment 142. The second radial extension portion 186 extends from the second sloped portion 180 in the radially inward direction, which provides a radial inward adjustment for the end loop segment 140. The end loop segments 188 and 190 are substantially identical to the end loop segment 140.

Similarly, an end loop segment 192 of the second layer 154 is shown adjacent the end loop segment 190 of the first layer 122. The end loop segment 192 includes a first sloped portion 194 and a second sloped portion 196 connected by an apex portion 198. The first sloped portion 194 is substantially co-radial with the slot segments 176 of the second layer 154. The second sloped portion 196 is substantially non-co-radial with the slot segments 176 of the second layer 154. The apex portion 198 includes a first radial extension portion 200. The first radial extension portion 200 extends from the first sloped portion 194 in the radially outward direction, which provides a radial outward adjustment for the end loop segment 192. A second radial extension portion 202 connects the second sloped portion 196 and the slot segment 176. The second radial extension portion 202 extends from the second sloped portion 196 in the radially inward direction, which provides a radial inward adjustment for the end loop segment 192. The end loop segments 204 and 206 are substantially identical to the end loop segment 192.

The slot segments, such as 138, 142, and 176 of each phase of the stator winding 50 are preferably disposed in respective core slots 12 at an equal slot pitch around the circumference of the stator core 10. Specifically, a slot segment of a phase, such as the slot segment 138, is disposed in a respective core slot 12 adjacent a slot segment 139 of the adjacent phase. The respective slot segments 138 and 139 are spaced apart by a circumferential distance or slot pitch 208, best seen in FIG. 7a. The circumferential slot pitch 208 is substantially equal to the circumferential distance between a pair of adjacent core slots 12 in the stator core 20. Each of the slot segments and end loop segments of the phase including the slot segment 138 remain disposed adjacent the respective slot segments and end loop segments of the phase including the slot segment 139 at the same circumferential slot pitch 208 throughout the length of the stator winding 50 and throughout the circumference of the stator core 20.

While the slot segments 176 are shown generally coplanar in FIGS. 7b and 7c for illustrative purposes, the slot segments 176 are preferably adapted to be received by a radially curved surface, such as the interior surface of the stator core 10 and, therefore, are not coplanar but are co-radial. The width of each of the slot segments 176, including any insulation, preferably fits closely to the width of the core slots 12, including any insulation.

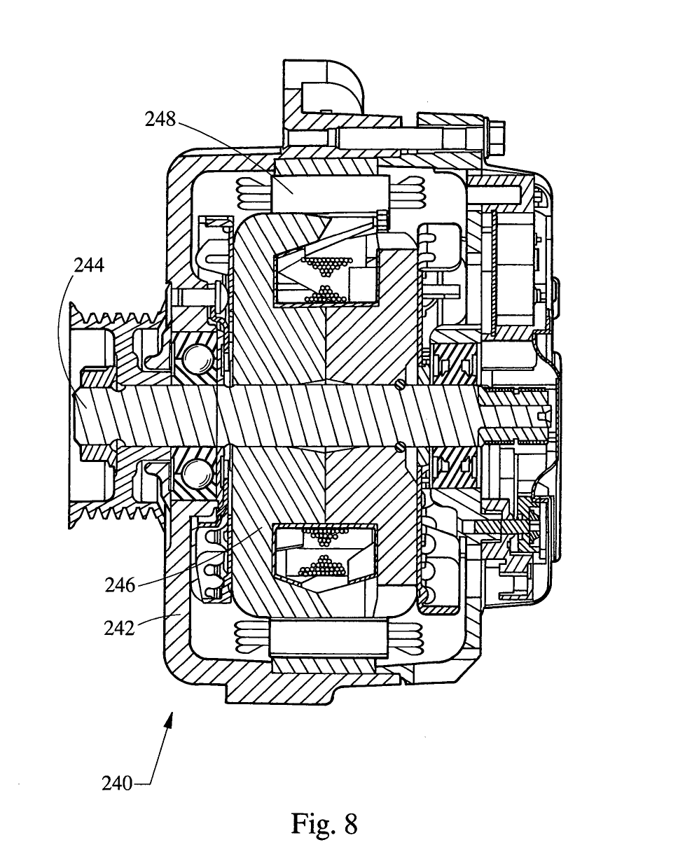

Referring now to FIG. 8, a dynamoelectric machine in accordance with the present invention is indicated generally at 240. The dynamoelectric machine 240 is preferably an alternator, but those skilled in the art will appreciate that the dynamoelectric machine 240 can be, but is not limited to, an electric motor, a starter-generator, or the like. The dynamoelectric machine 240 includes a housing 242 having a shaft 244 rotatably supported by the housing 242. A rotor assembly 246 is supported by and adapted to rotate with the shaft 244. The rotor assembly 246 can be, but is not limited to, a “claw pole” rotor, a permanent magnet non claw pole rotor, a permanent magnet claw pole rotor, salient field wound rotor, or an induction type rotor. A stator assembly 248 is fixedly disposed in the housing 242 adjacent the rotor assembly 246. The stator assembly 248 includes a stator core, such as the stator core 10 and a winding, such as the stator winding 50.

In accordance with the provisions of the patent statutes, the present invention has been described in what is considered to represent its preferred embodiment. However, it should be noted that the invention can be practiced otherwise than as specifically illustrated and described.

What is claimed is:

1. A stator for an electric machine, comprising:
a generally cylindrically-shaped stator core having a plurality of circumferentially-spaced and axially-extending core teeth that define a plurality of circumferentially-spaced and axially-extending core slots in a surface thereof, said core slots extending between a first and a second end of said stator core; and
a stator winding having a plurality of phases, each of said phases including at least one conductor having a plurality of slot segments housed in said core slots, said slot segments alternately connected at said first and second ends of said stator core by a plurality of end loop segments,
said stator core defining an inner diameter and each of said core slots having an end, said slot segments only partially filling said core slots between said inner diameter and said end such that there is empty space between said inner diameter and said end within each of said core slots.

2. The stator according to claim 1 wherein said slot segments are positioned adjacent said inner diameter such that there is empty space between said slot segments and said ends of said core slots within each of said core slots.

3. The stator according to claim 1 wherein said slot segments are positioned adjacent said ends of said core slots such that there is empty space between said slot segments and said inner diameter of said stator core within each of said core slots.

4. The stator according to claim 1 wherein said slot segments are positioned between said inner diameter and said ends of said core slots such that there is empty space between said slot segments and said inner diameter of said stator core and there is empty space between said slot segments and said ends of said core slots within each of said core slots.

5. The stator according to claim 1 further including a filler material placed within the empty space within at least one core slot.

6. The stator of claim 5 wherein said filler material keeps said winding in position within the core slots.

7. The stator of claim 5 wherein said filler material is a dampening material adapted to dampen vibration and noise within said stator.

8. The stator of claim 1 wherein said winding is held in place within said core slots by a varnish.

9. The stator according to claim 1 wherein said slot segments are inserted into said core slots of said generally cylindrically-shaped stator core in a substantially radial direction.

10. The stator of claim 1 wherein at least half of said end loop segments connect a first slot segment housed in a radial position of a first core slot with another a second slot segment housed in the same radial position of a second core slot.

11. The stator of claim 10 wherein at least half of said end loop segments each include at least one substantially sloped portion.

12. The stator of claim 11 wherein at least half of said end loop segments each include at least two radial adjustments.

13. The stator of claim 12 wherein at least half of said end loop segments have a pitch greater than three.

14. The stator of claim 13 wherein said winding includes said conductors formed in a cascaded winding.

15. The stator according to claim 1 wherein said slot segments housed in said core slots are aligned in a radial row and have a rectangular cross section.

16. The stator according to claim 1 wherein a width of said slot segments, including any insulation, fits closely to the width of said core slots, including any insulation.

17. The stator according to claim 1 wherein at least one of said conductors of a particular one of said phases is formed of a continuous conductor.

18. A method of forming a stator of an electric machine comprising:
providing a generally cylindrically-shaped stator core having an inner diameter, an outer diameter, and a plurality of circumferentially-spaced and axially-extending core teeth that define a plurality of circumferentially-spaced and axially-extending core slots in a surface thereof, the core slots extending between a first and a second end of the stator core and each having an end;
providing a stator winding having a plurality of phases, each phase comprised of at least one conductor having a plurality of slot segments housed in the core slots, the slot segments alternately connected at the first and second ends of the stator core by a plurality of end loop segments;
inserting the slot segments into the core slots;
positioning the slot segments within the stator core such that the slot segments only partially fills the core slots and there is empty space between the inner diameter and the ends of the core slots within each of the core slots;
securing the slot segments and the winding within the core slots.

19. The method according to claim 18 including positioning the slot segments adjacent the inner diameter such that there is empty space between the slot segments and the end of the core slots within each of the core slots.

20. The method according to claim 18 including positioning the slot segments adjacent the outer diameter such that there is empty space between the slot segments and the inner diameter of the stator core within each of the core slots.

21. The method according to claim 18 including positioning the slot segments between the inner diameter and the ends of the core slots such that there is empty space between the slot segments and the inner diameter of the stator core and there is empty space between the slot segments and the ends of the core slots within each of the core slots.

22. The method according to claim 18 including placing a filler material within the empty space to secure the slot segments within the core slots.

23. The method according to claim 18 including placing a dampening material within the empty space to secure the slot segments within the core slots and to reduce noise and vibration within the stator core.

24. The method of claim 18 including placing a varnish on the winding to keep the slot segments and the winding positioned within the core slots.
